(19) United States
(12) Patent Application Publication
(10) Pub. No.: US 2017/0284385 A1
(43) Pub. Date: Oct. 5, 2017

(54) COUPLING ASSEMBLY FOR A POWER END AND A FLUID END OF A PUMP

(71) Applicants: Terry Andrew Goss, Zanesville, OH (US); Douglas James Meredith, Kimbolton, OH (US); Samuel Weaver, Adamsville, OH (US)

(72) Inventors: Terry Andrew Goss, Zanesville, OH (US); Douglas James Meredith, Kimbolton, OH (US); Samuel Weaver, Adamsville, OH (US)

(21) Appl. No.: 15/089,562

(22) Filed: Apr. 3, 2016

(51) Int. Cl. F04B 39/14; F16D 1/02

(52) U.S. Cl. CPC F04B 39/14; F16D 1/02

(57) ABSTRACT

A mounting assembly mounts a fluid end unit to a power end unit and includes first and second end members, and a coupling. A first end of the first end member is a threaded shaft configured to be received in a mounting aperture of a power end unit. A first end of the second end member is a threaded shaft configured to be received in a mounting aperture of a fluid end unit corresponding to the mounting aperture of the power end unit. The coupling couples and extends the first end member and the second end member and may be removed therefrom without changing a relative position of the second end member to the first end member.

### TECHNICAL FIELD

The present disclosure relates to the field of oil and gas extraction and, in particular, pumps used for oil and gas extraction.

### BACKGROUND

Pumps used in oil and gas extraction, such as with hydraulic fracturing, are high-powered pumps that typically include two primary mechanisms, a power end (e.g., power end unit) and a fluid end (e.g., a fluid end unit). The power end unit produces or otherwise outputs mechanical energy that operates the fluid end unit, which in turn pumps liquid at high pressures (e.g., up to approximately 15,000 psi or more) and/or flow rates (e.g., up to approximately 100 barrels per minute or more) depending on the application.

The fluid end unit is removably mounted to and supported by the power end unit. Structural components (e.g., stationary frames, plates, bases, or other members) of the power end unit and the fluid end unit are coupled to each other to prevent relative movement therebetween, while reciprocating components of the power end unit (e.g., one or more pistons or rods that move reciprocally relative to the structural components) are coupled to corresponding reciprocating components of the fluid end unit (e.g., one or more corresponding pistons, rods, or plungers) that are thereby moved in a reciprocating manner relative to the structural components to pump the liquid. For example, the power end unit includes one or more structural members positioned opposite and facing towards corresponding structural members of the fluid end unit, which are coupled to each other with solid rods (e.g., bolts). The fluid end unit may be coupled to and supported by multiple rods surrounding each set of reciprocating components (e.g., four or more rods surrounding each set of pistons/plungers, such as twelve rods for a triplex pump having three sets of pistons/plungers, or twenty rods for a quintuplex pump having five sets of pistons/plungers). Each of the rods has generally the same length extending generally horizontally or laterally between a first end coupled to the structural member of the power end unit and a second end coupled to the structural member of the fluid end unit. More specifically, the first end of each rod is threaded and received within a corresponding threaded aperture of the structural member of the power end unit. The second end is threaded and extends through a non-threaded aperture in the structural member of the fluid end unit with a nut being received on the threaded end to couple the rod to the fluid end unit.

### SUMMARY

In use, the rods described above are subject to fatigue and may fail from push/pull loading caused by the reciprocating action of the pistons/plunger operating at high pressures, other vibrations associated with operation of the power end unit and/or the fluid end unit, and from supporting the fluid end unit (e.g., weighing up to approximately 5000 pounds or more) on the power end unit. Upon failure of a single rod, the rod must be removed and replaced, which requires removing the fluid end unit from the power end unit. This process requires independently supporting the fluid end unit and disconnecting each solid rod from the fluid end unit, which may require equipment not readily available in the field (e.g., a crane to support the fluid end unit) and significant labor (e.g., three people and several total man hours) and result in significant down time (e.g., while waiting for equipment and/or during the repair itself).

In contrast, the teachings herein describe a mounting system compatible with existing/conventional and/or new power end units and fluid end units whereby failure at a single attachment location may be corrected without entirely removing the fluid end unit and/or without disconnecting the fluid end unit at each of several attachment locations.

One embodiment of a mounting assembly for mounting a fluid end unit of a pump to a power end unit of the pump described herein includes a first end member, a second end member, and a coupling. The first end member extends between a first end and a second end. The first end of the first end member is a threaded shaft configured to be received in a mounting aperture of a power end unit to couple the first end member thereto. The second end member extends between a first end and a second end. The first end of the second end member is a threaded shaft configured to be received in a mounting aperture of a fluid end unit corresponding to the mounting aperture of the power end unit. The coupling is configured to removably couple to and extend between the second end of the first end member and the second end of the second end member. The coupling may be configured to be coupled to the second end of the first end member and the second end of the second end member without changing a relative position of the second end member to the first end member. The second end of the first member and the first bore may be cooperatively threaded to couple first end member to the coupling, and the second end of the second end member and the second bore may also be cooperatively threaded to couple the second end member to the coupling. Alternatively, the second end of the first end member may include a first plurality of radial flanges and the first bore may further include a first plurality of corresponding radial recesses to receive the first plurality of radial flanges to couple the first end member to the coupling, while the second end of the second end member may also include a second plurality of radial flanges and the second bore further may include a second plurality of corresponding radial recesses to receive the second plurality of radial flanges to couple the second end member to the coupling.

One embodiment of a connector assembly for mounting a fluid end unit of a pump to a power end unit of the pump described herein comprises a first member, a second member, and a cylindrical connector. The first member includes a first threaded shaft and a second threaded shaft. The first threaded shaft is configured to couple to the power end unit, and the second threaded shaft is coaxial with and extends away from the first threaded shaft. The second member includes a first threaded shaft and a second threaded shaft. The first threaded shaft is configured to couple to the fluid end unit, and the second threaded shaft is coaxial with and extends away from the first threaded shaft. The cylindrical connector includes a first connector member and a second connector member that each form approximately one half of the cylindrical connector, and define a first threaded bore at a first axial end of the connector and a second threaded bore at a second axial end of the connector. The first threaded bore is for coupling to the second threaded shaft of the first member, and the second threaded bore is for coupling to the second threaded shaft of the second member. The connector assembly is configured to extend laterally from the power end unit to support the fluid end unit.

An embodiment of a pump described herein includes a power end unit, a fluid end unit, and a mounting system that mounts the fluid end unit to the power end unit. The power end unit includes a first structural member and a first reciprocating member, and is configured to output mechanical energy by reciprocally moving the first reciprocating member relative to the structural member. The structural member includes a plurality of first mounting locations. The fluid end unit comprises a second structural member and a second reciprocating member configured to be moved reciprocally relative to the second structural member by the first reciprocating member, and is configured to pump a liquid via the second reciprocating member. The second structural member includes a plurality of second mounting locations that are each aligned with an associated one of the first mounting locations. The mounting system that mounts the fluid end unit to the power end by coupling the first structural member to the second structural member. The mounting system includes a plurality of mounting assemblies that each comprise a first end member, a second end member, and a coupling. The first end member is removably coupled to the first structure at one of the first mounting locations. The second end member is removably coupled to the second structure at the second mounting location associated with the first mounting location. The coupling includes a first end and a second end. The first end is removably coupled to the first end member, which may be with a first threaded connection, and the second end is removably coupled to the second end member, which may be with a second threaded connection. Each mounting assembly may be removed from the pump without moving the fluid end unit relative to the power end unit.

These and other aspects of the present disclosure are disclosed in the following detailed description of the embodiments, the appended claims and the accompanying figures.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a perspective view of a pump according to an embodiment.

FIG. 1B is a side view of the pump shown in FIG. 1A.

FIG. 2A is an upper right perspective view of a mounting assembly of the pump shown in FIG. 1.

FIG. 2B is an upper left perspective view of the mounting assembly shown in FIG. 2A.

FIG. 2C is a front plan view of the mounting assembly shown in FIG. 2A.

FIG. 3A is a perspective view of a first end member of the mounting assembly shown in FIGS. 2A-2C.

FIG. 3B is a side plan view of the first end member shown in FIG. 3A.

FIG. 3C is a front plan view of the first end member shown in FIG. 3B.

FIG. 4A is a perspective view of a second end member of the mounting assembly shown in FIGS. 2A-2C.

FIG. 4B is a side plan view of the second end member shown in FIG. 4A.

FIG. 4C is a front plan view of the second end member shown in FIG. 4A.

FIG. 5A is a perspective view of a coupling of the mounting assembly shown in FIGS. 2A-2C.

FIG. 5B is a side plan view of the coupling shown in FIG. 5A with various internal features shown in phantom.

FIG. 5C is a front plan view of the coupling shown in FIG. 5A.

FIG. 5D is a top plan view of a coupling member of the coupling shown in FIG. z,999

FIG. 6A is a front plan view of another mounting assembly.

FIG. 6B is a side plan view of a first end member shown in FIG. 6A.

FIG. 6C is a side plan view of a second end member shown in FIG. 6A.

FIG. 6D is a top plan view of a coupling member of the coupling shown in FIG. 6A.

FIG. 7A is a front plan view of another mounting assembly.

FIG. 7B is a side plan view of a first end member shown in FIG. 7A.

FIG. 7C is a side plan view of a second end member shown in FIG. 7A.

FIG. 7D is a top plan view of a coupling member of the coupling shown in FIG. 7A.

### DETAILED DESCRIPTION

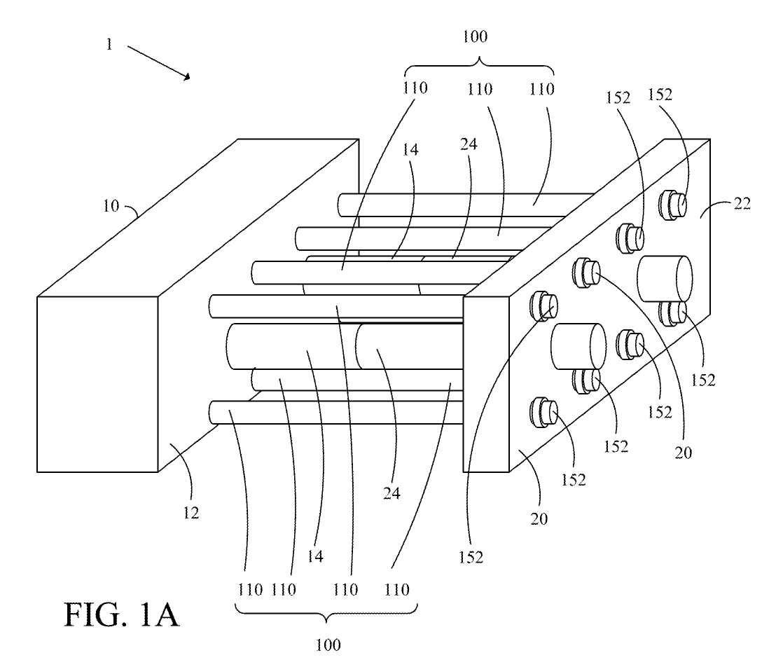

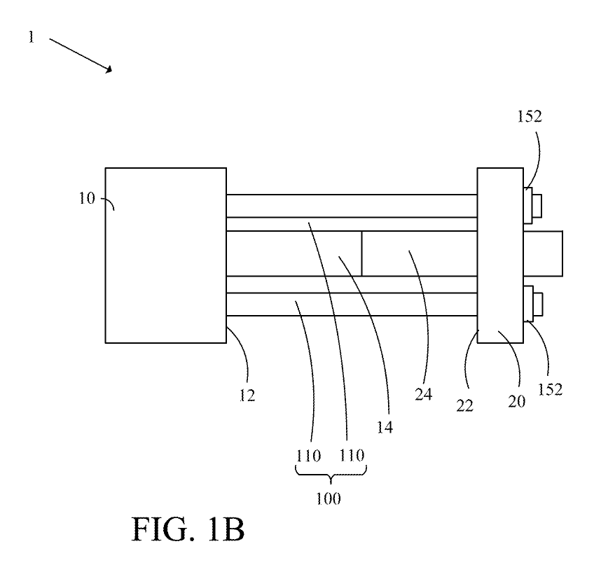

As shown in FIG. 1, a pump 1 includes a power end unit 10 and a fluid end unit 20 mounted to the power end unit 10 with a mounting system 100. The power end unit 10 is configured as described above and includes one or more structural members 12 (e.g., a mounting or stationary member, such as a plate or frame member), a plurality of reciprocating members 14 (e.g., pistons, rods, etc.) extending and reciprocating through or between the structural member 12, and a plurality of mounting apertures (not shown) at mounting locations of the structural member 12. The fluid end unit 20 is configured as described above and includes a structural member 22 (e.g., a mounting or stationary member, such as a plate or frame member), a plurality of reciprocating members 24 (e.g., pistons, plungers, rods, etc.) extending and reciprocating through and between the structural member 22, and a plurality of mounting apertures (not shown) at mounting locations in the structural member 22 that are aligned with the mounting locations of the structural member 12. The structural member 12 of the power end unit 10 is coupled to the structural member 22 of the fluid end unit 20 by the mounting system 100 to hold and support the fluid end unit 20 in a fixed relationship with the power end unit 10, while each reciprocating member 14 of the power end unit 10 is coupled (directly or indirectly) to a corresponding one of the reciprocating members 24 of the fluid end unit 20 to reciprocate therewith.

The mounting system 100 includes a plurality of mounting assemblies 110 (e.g., rod or bolt assembly, or connector). For example, four mounting assemblies 110 may be associated with and positioned around each pair of reciprocating members 14, 24. Each mounting assembly 110 is configured to be installed and/or removed from the pump 1 independent of each other mounting assembly 110 and without removing the fluid end unit 20 from the power end unit 10. Stated differently, each mounting assembly 110 is configured to couple the power end unit 10 to the fluid end unit 20 in a manner that does not require changing a relative position of the power end unit 10 to the fluid end unit 20 as the mounting assembly 110 is installed or removed.

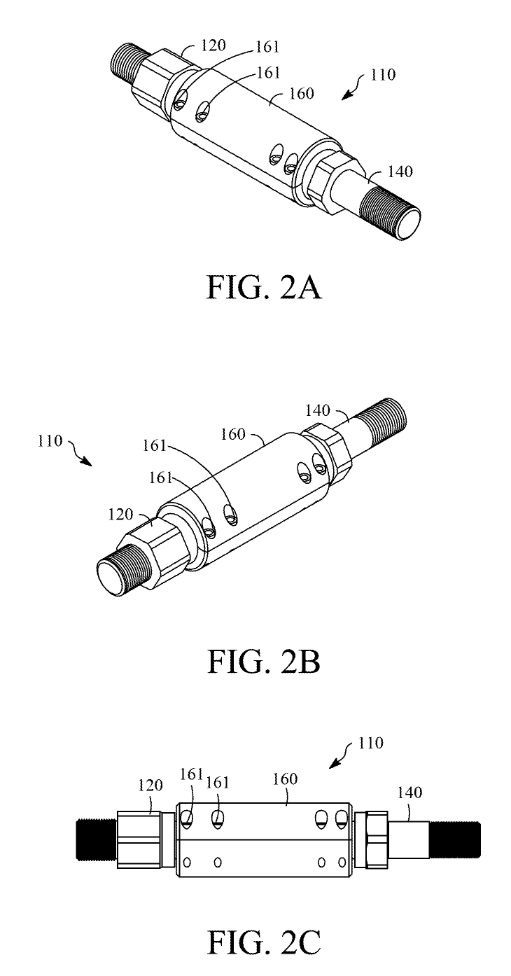

As shown in FIGS. 2A-2C, each mounting assembly 110 generally includes a first end member 120 configured to couple to the structural member 12 of the power end unit 10, a second end member 140 configured to couple to the structural member 22 of the fluid end unit 20, and a coupling 160 (e.g., a shaft, shank, or coupling subassembly) extending between and removably coupling the first end member 120 to the second end member 140. With each mounting assembly 110 being configured as an assembly with multiple, smaller separable components, the mounting assembly 110 may be disassembled and removed from the pump 1, as well as inserted and assembled in the pump 1, independent of the other mounting assemblies 110 and without removal of the fluid end unit 20 from the power end unit 10. Stated differently and as discussed in further detail below, the coupling 160 is configured to couple the first end member 120 to the second end member 140 in a manner that does not require changing a relative position of the first end member 120 the second end member 140 and, thereby, does not require changing a relative position of the power end unit 10 to the fluid end unit 20.

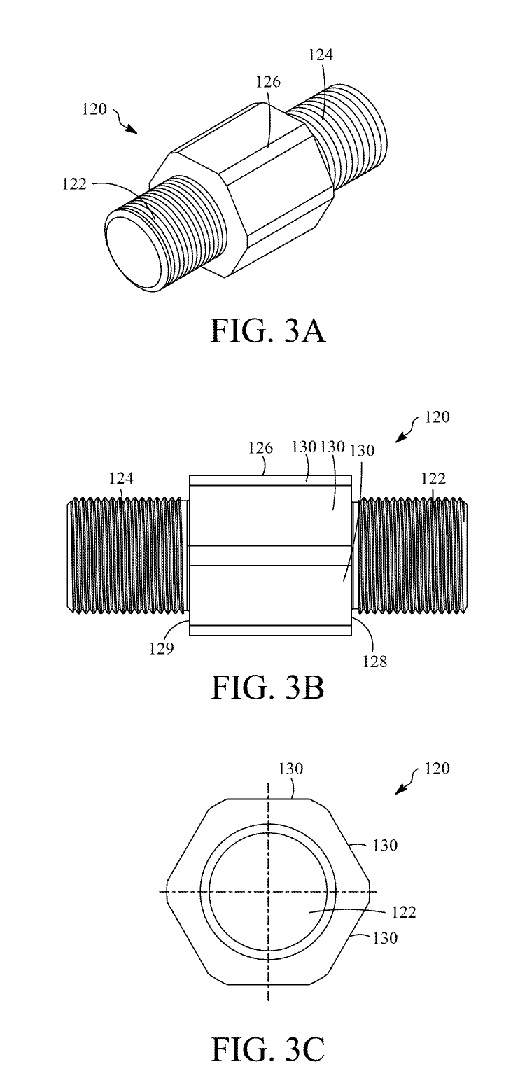

As shown in FIGS. 3A-3C, the first end member 120 is a unitary member having a first end 122 (e.g., a first or power end portion, segment, or shaft), a second end 124 (e.g., a second or coupling end portion, segment, or shaft), and a body 126 (e.g., a central, intermediate, or body portion or segment) extending between the first end 122 and the second end 124. The first end 122 is configured to removably couple to the structural member 12 of the power end unit 10. The first end 122 forms a threaded shaft having a central axis, which is configured to be threaded into the threaded mounting aperture of the structural member 12 of the power end unit 10 (e.g., having a corresponding diameter, axial length, and thread pattern). The first end 122 is configured to provide a sufficiently strong connection to the structural member 12 of the power end unit 10 to support the fluid end unit 20 thereon, which may be provided, for example, with a sufficiently large axial length, sufficiently large diameter, and appropriate thread pattern depending on the particular power end unit 10 and fluid end unit 20. In one example, the axial length is approximately 2 inches measured from the body 126 to be inserted into the mounting aperture, the diameter is between approximately one and 2.5 inches, such as approximately 2 inches, and the thread pattern is eight threads per inch. The first end 122 may be configured in other manners (e.g., different axial length, diameter, thread pattern, and connection to the structural member 12, such as with a nut engaging an opposed surface of the structural member 12), as may be appropriate for a given application (e.g., different power end unit 10 with different existing or designed mounting apertures, for example, being different in number and/or length, diameter, and thread pattern).

The second end 124 of the first end member 120 is configured to removably couple to the coupling 160. The second end 124 forms a threaded shaft that is generally coaxial with the first end 122. The second end 124 is configured to be received or positioned in a first bore 166 of a first end 162 of the coupling 160 (i.e., between two coupling members 160a, 160b) as discussed in further detail below. The second end 124 provides a sufficiently strong connection to the coupling 160 to support the fluid end unit 20, which may be provided with a sufficiently large axial length, sufficiently large diameter, and appropriate thread pattern, or other configurations/dimensions as may be required for a particular application (e.g., particular power end unit 10 and fluid end unit 20). In some embodiments, the second end 124 may have the same axial length, diameter, and thread pattern, or other configurations/dimensions, as the first end 122.

The body 126 is generally coaxial with the first end 122 and the second end 124. At all positions along its axial length, the body 126 has a larger cross-sectional diameter than the first end 122 and the second end 124, and may include filleted transitions moving in an axial direction from the body 126 to the smaller diameters of the first end 122 and the second end 124. The body 126 forms a first shoulder 128 and a second shoulder 129 (e.g., extending at approximately 90 degrees from the central axis). The first shoulder axially engages a surface of the structural member 12 (i.e., the surface facing the fluid end unit 20), thereby allowing the first end member 120 to be tightened in the mounting aperture to be retained therein by pressing against the surface of the structural member 12 and causing teeth of the first end 122 to press against teeth in the mounting aperture of the structural member 12. By engaging and bearing against the surface of the structural member 12 around the mounting aperture, the shoulder 128 may additionally prevent pivoting of the first end member 120 relative to the structural member 12 (e.g., from supporting the weight of the fluid end unit 20 positioned laterally thereto). In the mounting assembly 110, the second shoulder 129 is positioned adjacent the coupling 160 and is spaced apart therefrom (e.g., ⅛ turn) or may directly engage the coupling 160. The body 126 additionally includes hexagonal faceted surfaces 130, which are flats or flat regions extending in a circumferential direction. The faceted surfaces 130 are configured to receive and be engaged by a conventional wrench or torque wrench for tightening the first end member 120 within the mounting aperture and to the structural member 12 of the power end unit 10. The faceted surfaces 130 extend between the shoulders 128, 129 the entire axial length of the body 126. According to other embodiments, the faceted surfaces 130 may extend only a portion of the axial length of the body 126. The body 126 may have a length of approximately 2.75 inches, a maximum diameter of approximately 3 inches, and spacing of the faceted surfaces 130 of approximately 2.75 inches, or other dimensions as may be suitable for a particular application (e.g., greater or lesser diameter, length, and/or facet spacing).

The first end member 120 may, for example, be made from a steel alloy, or other suitable material providing suitable characteristics to mount the fluid end unit 20 to the power end unit 10 (e.g., strength and fatigue characteristics, environmental tolerances, etc.). The end member 120 may, for example, be formed from a unitary piece of stock material, for example, cylindrical stock that is machined to include its various features such as ends 122, 124 having particular diameters and thread patterns, faceted surfaces 130 (e.g., flats), etc. The first end member 120 may, for example, have an overall length of approximately 7 inches, or other length as may be appropriate for a given application.

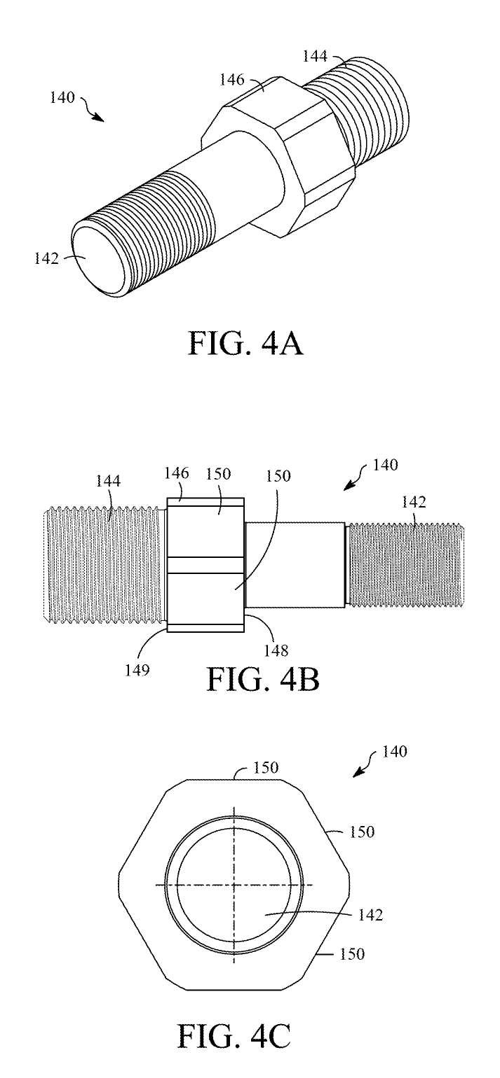

As shown in FIG. 4A-4C, the second end member 140 is a unitary member having a first end 142 (e.g., a first or fluid end portion, segment, or shaft), a second end 144 (e.g., a second or coupling end portion, segment, or shaft), and a body 146 (e.g., a central, intermediate, or body portion or segment) extending between the first end 142 and the second end 144. The first end 142 is configured to removably couple to the structural member 22 of the fluid end unit 20. The first end 142 forms a shaft that is at least partially threaded, so as to receive a nut 152 thereon, and that is configured to be inserted through the structural member 22 of the fluid end unit 20. An unthreaded portion of the first end 142 may be positioned axially inward of the threaded portion to be positioned against circumferential surfaces of the mounting aperture of the structural member 22. The first end 142 is configured to provide a sufficiently strong connection to the structural member 22 of the fluid end unit 20 so as to support the fluid end unit 20, for example, with a sufficiently large axial length, sufficiently large diameter, and appropriate thread pattern depending on the requirements and configurations of the power end unit 10 and the fluid end unit 20. In one example, the axial length is approximately 4.5 inches of which approximately 2.5 inches form a threaded portion, and approximately 2 inches form an unthreaded portion adjacent the body 146, the diameter is between approximately one and 2.5 inches, such as approximately 1.75 inches, and the thread pattern is eight threads per inch. The first end 142 may be configured in other manners (e.g., different axial length, diameter, thread pattern, and connection to the structural member 22, such as being threaded into a threaded aperture), as may be appropriate for a given application (e.g., a different fluid end unit 20 with different existing or designed mounting apertures, for example, being different in number and/or length, diameter, and thread pattern). To facilitate manufacturing (e.g., locating during machining), a hole or recess (e.g., a live center) may be provided at one or more ends of the second end member 140

The second end 144 of the second end member 140 is configured to removably couple to the coupling 160. The second end 144 forms a threaded shaft that is generally coaxial with the first end 142. The second end 144 is configured to be received or positioned in a second bore 168 of a second end 164 of the coupling 160 (i.e., between two coupling members 160a, 160b) discussed in further detail below. The second end 144 provides a sufficiently strong connection to the coupling 160 to support the fluid end unit 20, which may be provided, for example, with a sufficiently large axial length, sufficiently large diameter, and appropriate thread pattern, or other configurations/dimensions as may be required for a given application (e.g., a particular power end unit 10 and fluid end unit 20). In one example, the axial length is approximately 2 inches measured from the body 146, the diameter is approximately 2 inches, and the thread pattern is eight threads per inch.

The body 146 is generally coaxial with the first end 142 and the second end 144. At all positions along its axial length, the body 146 has a larger cross-sectional diameter than the first end 142 and the second end 144, and may include filleted transitions to the smaller diameters of the first end 142 and the second end 144. The body 146 forms a first shoulder 148 and a second shoulder 149 (e.g., extending at approximately 90 degrees from the central axis). The first shoulder 148 axially engages a surface of the structural member 22 (i.e., the surface facing the power end unit 10), thereby allowing structural member 22 of the fluid end unit 20 to be tightened (i.e., compressed) between the nut 152 and the shoulder 148. By engaging and bearing against the surface of the structural member 22 around the mounting aperture, the shoulder 148 may additionally prevent pivoting of the second end member 140 relative to the structural member 22 (e.g., from supporting the weight of the fluid end unit 20 positioned laterally thereto). In the mounting assembly 110, the second shoulder 149 is positioned adjacent the coupling 160 and is spaced apart therefrom (e.g., ⅛ turn) or may directly engage the coupling 160. The body 146 additionally includes hexagonal faceted surfaces 150 (e.g., positioned adjacent the shoulder 148), which are configured to receive and be engaged by a conventional wrench to hold the second end member 140 in a rotational position, while the nut 152 is tightened to the first end 142 thereof. The faceted surfaces 150 extend between the shoulders 148, 149 the entire axial length of the body 146. According to other embodiments, the faceted surfaces 150 may extend only a portion of the axial length of the body 146. The body 146 may have a length of approximately 1.5 inches, a maximum diameter of approximately 3 inches, and spacing of the faceted surfaces 150 of approximately 2.75 inches, or other dimensions as may be suitable for a particular application (e.g., greater or lesser diameter, length, and/or facet spacing).

The second end member 140 may be made from similar materials (e.g., steel alloy) and similar methods (e.g., machining from cylindrical stock) as the first end member 120 described above. The second end member 140 may have an overall length of approximately 8 inches, for example, or other length as may be appropriate for a given application.

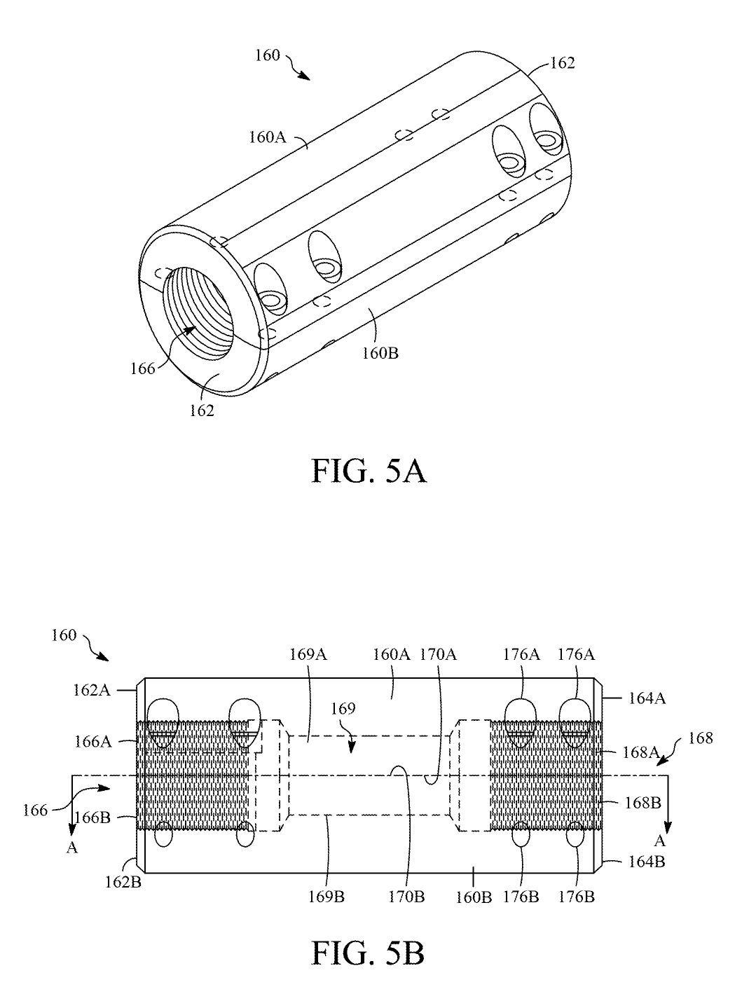

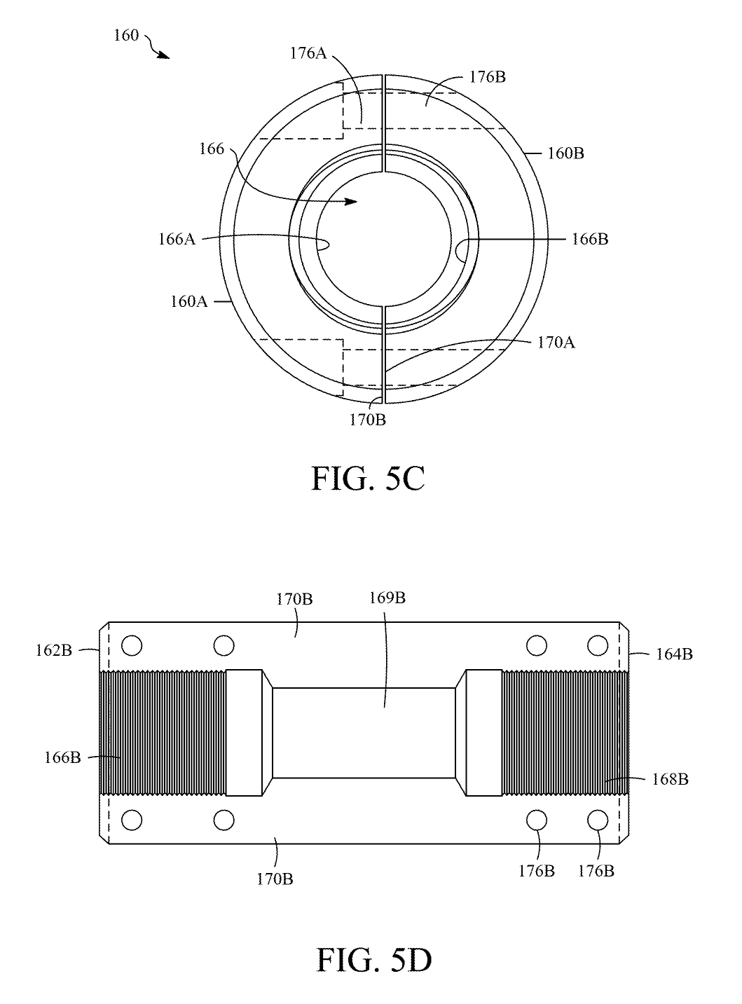

As shown in FIGS. 5A-5D, the coupling 160 is a multicomponent subassembly that forms an intermediate or central shaft or shank that extends between and couples the first end member 120 to the second end member 140 to form a rigid mounting assembly 110. The coupling 160 includes first and second coupling members 160a, 160b that individually form approximate circumferential halves of the coupling 160, which are positioned around the second ends 124, 144 of the first and second end members 120, 140. The first and second coupling members 160a, 160b may be approximate mirror images of each other. The first and second coupling members 160a, 160b extend circumferentially approximately 180 degrees (or less) between circumferential ends 170a, 170b, respectively, thereof (i.e., facing a tangential direction relative to the central axis), and extend axially between first axial ends 162a, 162b and second axial ends 164a, 164b, thereof. With the circumferential ends 170a, 170b positioned adjacent and/or engaging each other, the first and second coupling members 160a, 160b cooperatively form the coupling 160 as a generally cylindrical, rigid subassembly extending axially between the first end 162 and the second end 164. When the coupling 160 is assembled, the coupling members 160a, 160b compress therebetween the second ends 124, 144 of the first and second end members 120, 140, which prevents rotation of the coupling 160 relative to the first and second end members 120, 140.

The first end 162 and the second end 164 of the coupling 160 each include a threaded bore (i.e., a first bore 166 and a second bore 168, respectively) configured to receive and couple to the second end 124 of the first end member 120 and the second end 144 of the second end member 140, respectively. The first bore 166 is cooperatively formed or defined by a first inner circumferential surface 166a of the first coupling member 160a and a first inner circumferential surface 166b of the second coupling member 160b, which face radially inward toward the central axis. The first bore 166 has a complementary diameter and thread pattern to the second end 124 of the first end member 120, so as to engage and couple to the threaded portion of the second end 124 of the first end member 120, the threads being formed on the first inner circumferential surfaces 166a, 166b of the first and second coupling members 160a, 160b, respectively. The threaded connection between the second end 124 and the bore 166 may provide for relative axial positioning therebetween. This relative axial positioning allows for adjustments to the axial length of the mounting assembly 110, for example, to account for variations in relative positioning and/or other inconsistencies of the structural member 12 of the power end unit 10 and the structural member 22 of the fluid end unit 20. The first bore 166 may additionally include an unthreaded region positioned axially inward of the threaded portion, which has a sufficient diameter to receive the threaded second end 124, so as to allow further relative axial movement between the coupling 160 the first end member 120. The second bore 168 is configured and formed similar to the first bore 166 with respect to the second end 144 of the second end member 140 (e.g., being defined by second inner circumferential surfaces 168a, 166b of the first and second coupling members 160a, 160b to have threaded and unthreaded regions complementary to the second end of the second end member 140).

The first and second bores 166, 168 may be in communication with each other via a third bore 169 having a smaller diameter than both the first and second bores 166, 168. The third bore 169 is defined or formed by third inner circumferential surfaces 169a, 169b of the first and second coupling members 160a, 160b, respectively (i.e., which face radially inward toward the central axis).

The first coupling member 160a and the second coupling member 160b are configured to be received around or removed from opposing sides of the second ends 124, 144 of the first and second end members 120, 140, respectively, in a radial direction. This receipt and removal in a radial direction provides for installing and removing the mounting assembly 110 from the pump 1 without moving the first end member 120 to the second end member 140 and, thereby, without moving the fluid end unit 20 relative to the power end unit 10.

The first and second coupling members 160a, 160b are configured to be coupled to each other with fasteners 161 received in corresponding apertures 176a, 176b, respectively, thereof. The threaded fasteners 161 (e.g., socket head capscrews) pull the first and second coupling members 160a, 160b until the circumferential ends 170a, 170b tightly engage each other, the inner circumferential surfaces 166a, 166b tightly engage the second end 124 of the first end member 120, and/or the inner circumferential surfaces 168a, 168b tightly engage the second end 144 of the second end member 140. The apertures 176a, 176b and, thereby the fasteners 161, are positioned radially outward of the first and second bores 166, 168 and extend in a tangential direction relative to the central axis (e.g., generally perpendicular to the circumferential ends 170a, 170b). Each aperture 176a of the first coupling member 160a may be threaded or unthreaded and include a flange surrounding the aperture to receive a head of the fastener 161 thereagainst, while the apertures 176b of the second coupling member 160b may be threaded to receive and engage threads of the fastener 161. For example, the first coupling member 160a may include eight total unthreaded apertures 176a, two apertures 176a being spaced along each of two sides of each of the first and second inner circumferential surfaces 166a, 168a, while the second coupling member 160b includes eight corresponding threaded apertures 176b similarly positioned along sides of the first and second inner circumferential surfaces 166b, 168b. The apertures 176a, 176b may, for example, being configured to receive bolts having a nominal diameter of ⅜ inch with 24 threads per inch, or other suitable fasteners.

Each of the coupling members 160a, 160b may, for example, be made from a steel alloy, or other suitable material providing suitable characteristics to mount the fluid end unit 20 to the power end unit 10 (e.g., strength and fatigue characteristics, environmental tolerances, etc.). The coupling members 160a, 160b may, for example, be formed from a unitary piece of cylindrical stock that is machined and split to form the two coupling members 160a, 160b, or from separate pieces of material that are formed into the coupling members 160a, 160b (e.g., cast or stock material that is machined).

The coupling 160 may, for example, have an overall length of approximately 8.5 inches and an outer diameter of approximately 3.625 inches. The first and second bores 166, 168 may, for example, have an overall length of approximately 2.5 inches of which the threaded portion has an axial length of approximately 2 inches and the unthreaded portion has an axial length of approximately ½ inch. The first and second bores 166, 168 may additionally have a nominal diameter (e.g., approximately 2 inches) and thread pattern (e.g., eight threads per inch) that correspond to those of the second ends 124, 144 of the first and second end members 120, 140. The third bore 169 may, for example, have a nominal diameter of approximately 1.5 inches. The outer diameter and bore diameters result in wall thickness of the first and second coupling members 160a, 160b of approximately ¾ inch at the first and second bores 166, 168 and of approximately one inch at the third bore 169. According to other exemplary embodiments, the diameters, lengths, thread pattern, and wall thicknesses may be altered to depending on the particular application.

Based on the dimensions of the first end member 120, second end member 140, and the coupling 160, the mounting assembly 110 may have nominal, but adjustable, overall length of approximately 19 inches and a nominal, but adjustable, shoulder-to-shoulder axial length (i.e., between the shoulders 128, 148) of approximately 13 inches, or other lengths as may be required for a particular application (e.g., particular power end unit 10, fluid end unit 20, and required spacing therebetween).

In order to mount the fluid end unit 20 to the power end unit 10 with the mounting system 100, the power end unit 10 is moved to a desired position (e.g., a use position), and the fluid end unit 20 is temporarily supported (e.g., with a crane, removable frame, etc.) in a position relative to the power end unit 10 with the support members 12, 22 and corresponding mounting apertures in alignment.

The mounting assemblies 110 are then each coupled to the power end unit 10 and the fluid end unit 20. The first end member 120 is coupled to the structural member 12 of the power end unit 10 by inserting (i.e., threading) its first end 122 in one of the mounting apertures in the structural member 12 and tightening the first end member 120 therein to a final torque level (e.g., 2450 ft-lbs).

The second end member 140 is coupled to the structural member 22 of the fluid end unit 20 by inserting its first end 142 through one of the mounting apertures in the structural member 22 and tightening the nut 152 on the first end 142 to an initial or loose torque level, which allows for subsequent adjustment. After adjustments of the second end member 140 relative to the coupling 160 or the end unit 20 (as discussed below), the nut 152 is tightened to a final torque value (e.g., 2450 ft-lbs). This coupling of the second end member 140 may compress the structural member 22 between the nut 152 and the shoulder 148 of the second end member 140. The first end member 120 may be coupled to the power end unit 10 and/or the second end member 140 may be coupled to the fluid end unit 20 before or after the power end unit 10 and/or the fluid end unit 20 are moved into position, which may provide clearer access to the mounting apertures for coupling thereto.

After the first end member 120 is coupled to the power end unit 10 and the second end member 140 is coupled to the fluid end unit 20, and after the power end unit 10 and the fluid end unit 20 are moved into their final positions relative to each other, the coupling 160 is coupled to the first and second end members 120, 140. The first and second coupling members 160a, 160b are positioned around the second ends 124, 144 of the first and second end members 120, 140 in a radial direction (i.e., being moved generally perpendicular to the central axis passing through the first end member 120 and the second end member 140). More particularly, the inner circumferential surfaces 166a, 166b (forming the first bore 166) of the first and second coupling members 160a, 160b, respectively, are moved toward each other and toward the second end 124 of the first end member 120, such that the threads of the inner circumferential surfaces 166a, 166b engage and receive the threads of the second end 124 of the first end member 120. Additionally, the inner circumferential surfaces 168a, 168b (forming the second bore 168) of the first and second coupling members 160a, 160b, respectively, are moved toward each other and toward the second end 144 of the second end member 140, such that the threads of the circumferential surfaces 168a, 168b engage and receive the threads of the second end 144 of the second end member 140. Subsequently, the fasteners 161 are inserted in each of the apertures 176a, 176b and are tightened, so as to draw the first and second coupling members 160a, 160b toward each other. The fasteners 161 may be tightened in a single stage to a final torque level, or in multiple stages, such as initially to a preliminary or loose torque level and subsequently to a final torque level. The fasteners 161 bring the first and second coupling members 160a, 160b into tight engagement with each other and/or to compress the second ends 124, 144 of the first and second end members 120, 140, respectively.

As may be needed after the coupling 160 is coupled to the first end member 120 and the second end member 140, the second end member 140 may be adjusted and/or further tightened. For example, the second end member 140 may be adjusted by rotating the second end member 140 relative to the coupling 160 resulting in axial displacement relative to the coupling 160 (i.e., via the threaded connection in the bore 168), so as to engage a surface of the structural member 22. The nut 152 is then further tightened to its final torque level on the first end 142 of the second end member 140. In some installation methods, the second end member 140 may still be adjusted after the fasteners 161 are tightened to a final torque level (e.g., whether in one or multiple stages).

After each mounting assembly 110 of the mounting system 100 is installed according to the process described above, the temporary support is removed from the fluid end unit 20.

Individual mounting assemblies 110 may also be removed and/or replaced, for example, upon failure of one of the mounting assemblies 110 or component thereof. Removal and replacement of one of the mounting assemblies 110 can be performed independent of other mounting assemblies 110 and without entirely removing the fluid end unit 20 from the power end unit 10, or otherwise moving the fluid end unit 20 relative to the power end unit 10. To remove the mounting assembly 110, the coupling 160 is removed from the first and second end members 120, 140 by removing the fasteners 161 and moving the coupling members 160a, 160b out of engagement with the second ends 124, 144 of the first and second end members 120, 140. The first end member 120 may then be removed or decoupled (i.e., by unthreading) from the power end unit 10, and the second end member 140 may then be removed or decoupled by removing the nut 152, and extracting the first end 142 from the mounting aperture from the fluid end unit 20. If it is determined that the first end member 120 and/or the second end member 140 do not require replacement (e.g., because a failure occurred with another component of the mounting assembly 110), the first end member 120 and/or the second end member 140 may optionally not be removed.

To install an individual or replacement mounting assembly 110 (e.g., in place of a failed mounting assembly) or components thereof, the installation process described above is performed by coupling the first end member 120 to the power end unit 10 as may be required; coupling the second end member 140 to the fluid end unit 20 as may be required; coupling the coupling 160 to the first and second end members 120, 140; and as needed, adjusting and/or tightening the first and second end members 120, 140.

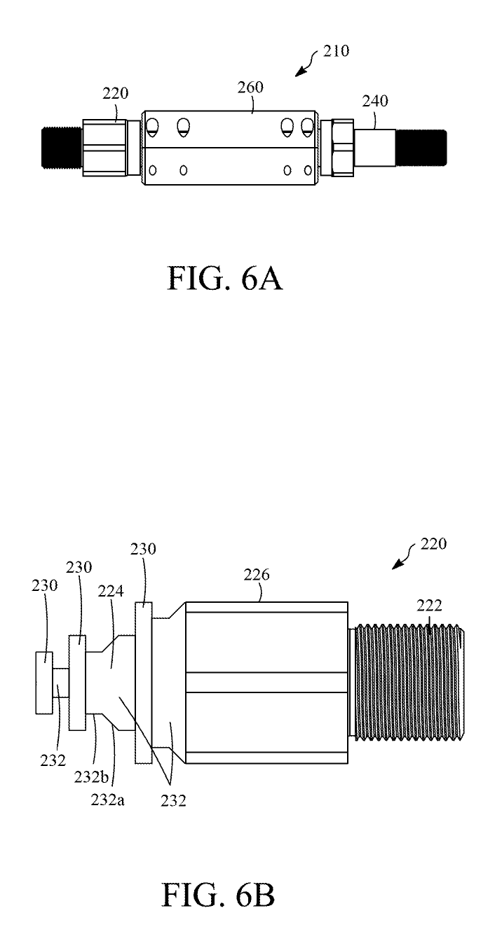

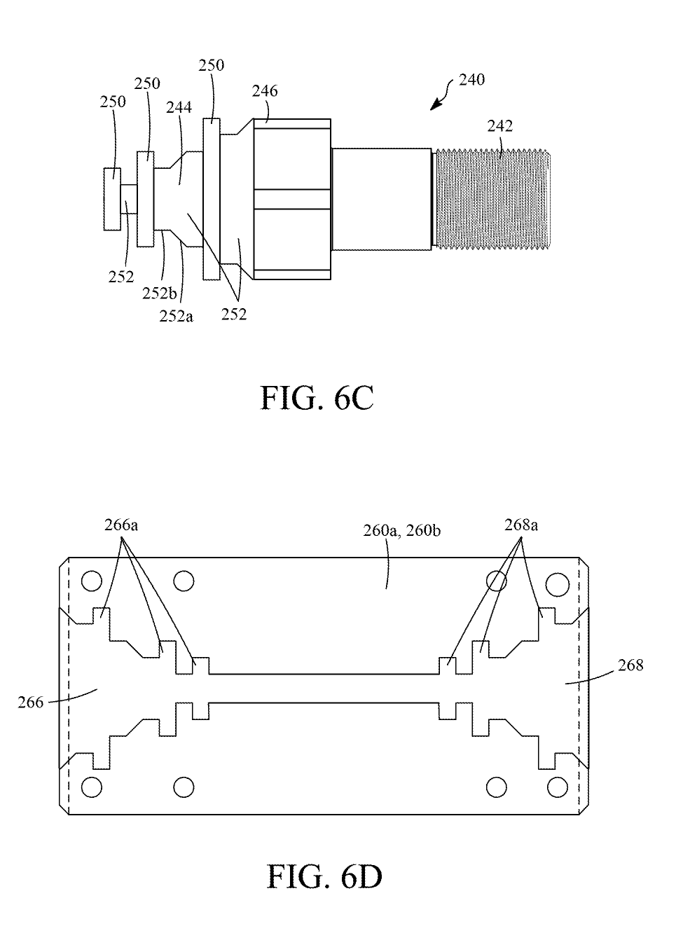

As shown in FIGS. 6A-6D, another exemplary embodiment of a mounting assembly 210 includes a first end member 220, a second end member 240, and a coupling 260. As compared to the mounting assembly 110, second ends 224 and 244 of the first and second end members 220, 240, respectively, and the coupling 260 include corresponding retention features that are non-threaded. The first end member 220 includes a first end 222 and a body 224 that are configured as described above for the first end member 120. The second end member 240 similarly includes a first end 242 and a body 246 that are configured as described above for the second end member 240. Instead, the second end 224 of the first end member 220 and/or the second end 244 of the second end member 260 include a series of radially extending flanges 230, 250 (e.g., barbs) that are received in a series of corresponding recesses of the coupling 260.

The second end 224 of the first end member 220 includes a plurality of radially-extending flanges 230 having circular peripheries. The radial flanges 230 are spaced apart along an axis of the first member 220 (e.g., are coaxial). The radial flanges 230 may have different radii from each other, for example, reducing in radius the further the radial flange 230 is spaced apart from the body 246. Each individual radial flange 230 may, itself, however, have a constant radius. The radial flanges 230 are spaced apart by intermediate shafts 232, which may include a tapered portion 232a (i.e., having a reducing radius) and/or a non-tapered portion 232b (i.e., having a constant radius). The tapered portion may engage a corresponding tapered portion of the coupling 260, which is then compressed between one of the radial flanges 230 and the tapered portion 232a of the shaft 232 in an axial direction. The second end 244 of the second end member 240 similarly includes radially extending flanges 250 and intermediate shafts 252 with tapered and non-tapered portions 252a, 252b, or may include other retention features (e.g., threads). According to other exemplary embodiments, the radial flanges 230, 250 may have non-circular peripheries (e.g., ovular, square or rectangular, interrupted with separate flange or barb elements, etc.).

The coupling 260 is configured substantially similar to the coupling 160, and includes two circumferential members 260a, 260b, but is adapted for receipt and retention of the second ends 224, 244 of the first and second end members 220, 240. In particular, the first bore 266 and the second bore 268 include radial recesses 266a, 268a that are shaped to receive and tightly fit (e.g., compress) the radial flanges 230, 250 of the first and second end members 220, 240 in a radial direction, while also engaging axial facing surfaces of the radial flanges 230, 250 to prevent relative axial movement therebetween. For example, the radial recesses 266a, 268a have radii that are approximately equal to or slightly smaller than the constant radii of each radial flange 230, 250, and widths that are approximately equal to or slightly larger than the widths of the radial flanges 230, 250.

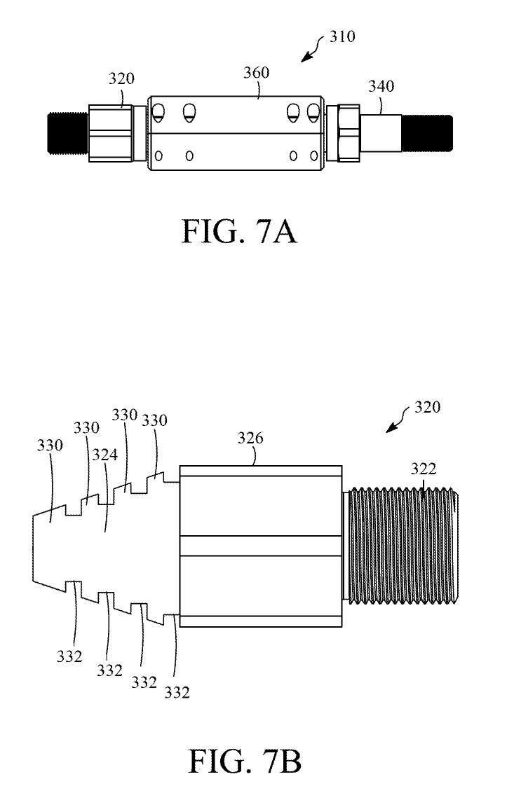

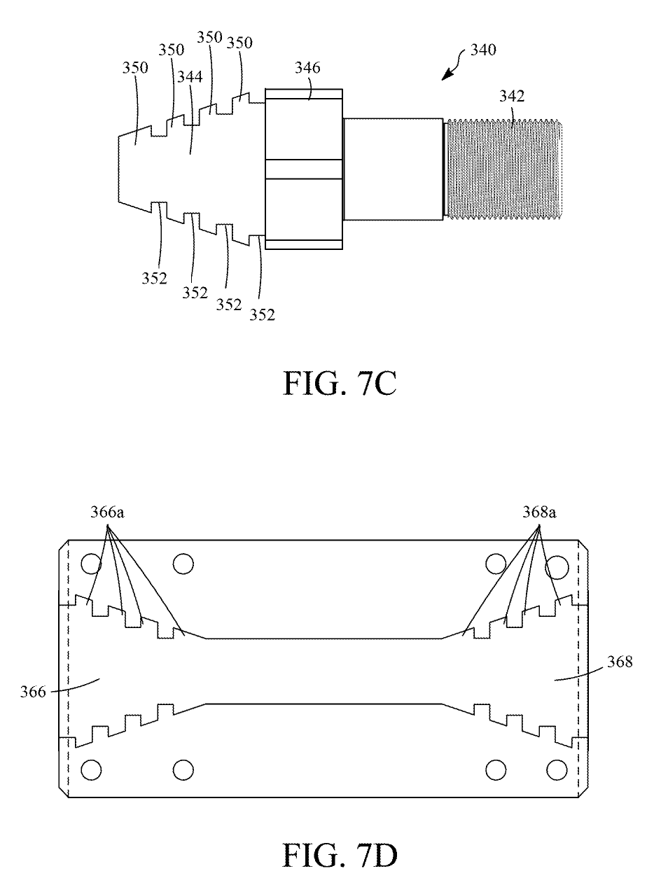

As shown in FIGS. 7A-7D, another exemplary embodiment of a mounting assembly 310 includes a first end member 320, a second end member 340, and a coupling 360. As compared to the mounting assembly 210, second ends 324 and 344 of the first and second end members 320, 340, respectively, differ in their configuration of circumferential flanges 330, 350 and intermediate shafts 332, 352 therebetween. In particular, each circumferential flange 330, 350 has a frustoconical outer periphery that reduces in radius moving away from the body 326, 346. Each successive circumferential flange 330, 350 reduces in radius moving away from the body 326, 346 as compared to the previous circumferential flange 330, 350, such that the outer peripheries of the flanges 330, 350 cooperatively form a frustoconical shape. Intermediate shaft portions 332, 352 between the radial flanges 330, 350 may each have a constant radius, while each successive intermediate shaft portion 332, 352 reduces in radius from the previous intermediate shaft portion 332, 352. According to other embodiments, the second ends 224, 244 of the first and second end members 220, 240 may have differently configured retention features from each other (e.g., threads, differently shaped radial flanges, etc.).

The coupling 360 is configured substantially similar to the coupling 260, and includes two circumferential members 360a, 360b, but is adapted for receipt and retention of the second ends 324, 344 of the first and second end members 320, 340. In particular, the first bore 366 and the second bore 368 include radial recesses 366a, 368a that are shaped to receive and tightly fit (e.g., compress) the radial flanges 330, 350 of the first and second end members 320, 340. For example, the radial recesses 366a, 368a have radii that are approximately equal to or slightly smaller than the reducing radii (i.e., forming a frustoconical shape) of each radial flange 330, 350.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A mounting assembly for mounting a fluid end unit of a pump to a power end unit of the pump, the mounting assembly comprising:
a first end member extending between a first end and a second end, the first end of the first end member being a threaded shaft configured to be received in a mounting aperture of a power end unit to couple the first end member thereto;
a second end member extending between a first end and a second end, the first end of the second end member being a threaded shaft configured to be received in a mounting aperture of a fluid end unit corresponding to the mounting aperture of the power end unit to couple the second end member thereto; and
a coupling configured to removably couple to and extend between the second end of the first end member and the second end of the second end member.

2. The mounting assembly of claim 1, wherein the coupling is configured to be coupled to the second end of the first end member and the second end of the second end member without moving the second end member relative to the first end member.

3. The mounting assembly of claim 2, wherein the coupling includes a first bore and a second bore, the first bore being configured to receive the second end of the first end member therein, and the second bore being configured to receive the second end of the second end member therein.

4. The mounting assembly of claim 3, wherein the second end of the first end member and the first bore are cooperatively threaded to couple first end member to the coupling, and the second end of the second end member and the second bore are cooperatively threaded to couple the second end member to the coupling.

5. The mounting assembly of claim 3, wherein the second end of the first end member includes a first plurality of radial flanges and the first bore includes a first plurality of corresponding radial recesses to receive the first plurality of radial flanges to couple the first end member to the coupling, and the second end of the second end member includes a second plurality of radial flanges and the second bore includes a second plurality of corresponding radial recesses to receive the second plurality of radial flanges to couple the second end member to the coupling.

6. The mounting assembly of claim 1, wherein the mounting assembly is configured to be coupled to the power end unit and the fluid end unit without moving the fluid end unit relative to the power end unit.

7. The mounting assembly of claim 6, wherein the coupling is configured to be coupled to the second end of the first end member and to the second end of the second end member after the first end member is coupled to the power end unit and after the second end member is coupled to the fluid end unit.

8. The mounting assembly of claim 1, wherein the coupling comprises a first coupling member and a second coupling member, the first coupling member and the second coupling member being configured to be received around the second end of the first end member and around the second end of the second end member in a radial direction.

9. The mounting assembly of claim 8, wherein first coupling member and the second coupling member cooperatively define a first bore and a second bore, the first bore being threaded and configured to couple to the second end of the first end member, and the second bore being threaded and configured to couple to the second end of the second end member.

10. The mounting assembly of claim 9, wherein a first inner circumferential surface of the first coupling member and a first inner circumferential surface of the second coupling member cooperatively define the first bore, and wherein a second inner circumferential surface of the first coupling member and a second inner circumferential surface of the second coupling member cooperatively define the second bore.

11. The mounting assembly of claim 10, wherein the first and second inner circumferential surfaces of the first and second coupling members include threads.

12. The mounting assembly of claim 6, wherein the second end of the first end member includes a first plurality of radial flanges, the second end of the second end member includes a second plurality of radial flanges, and the first coupling member and the second coupling member cooperatively define a first bore and a second bore, the first bore including a first plurality of radial recesses for receiving the first plurality of radial flanges to couple the first end member to the coupling, and the second bore including a second plurality of radial recesses for receiving the second plurality of radial flanges to couple the second end member to the coupling.

13. The mounting assembly of claim 8, wherein the first coupling member is coupled to the second coupling member with a plurality of fasteners that draw the first coupling member toward the second coupling member around the second end of the first end member and the second end of the second end member.

14. The mounting assembly of claim 8, wherein the coupling forms a cylinder, and the first coupling member and the second coupling member each form approximately one half of the cylinder.

15. A connector for mounting a fluid end unit of a pump to a power end unit of the pump, the connector comprising:
a first member having a first threaded shaft and a second threaded shaft, the first threaded shaft being configured to couple to the power end unit, and the second threaded shaft being coaxial with and extending away from the first threaded shaft;
a second member having a first threaded shaft and a second threaded shaft, the first threaded shaft being configured to couple to the fluid end unit, and the second threaded shaft being coaxial with and extending away from the first threaded shaft; and
a cylindrical connector having a first connector member and a second connector member that each form approximately one half of the cylindrical connector and which cooperatively define a first threaded bore at a first axial end of the connector for coupling to the second threaded shaft of the first member, and cooperatively define a second threaded bore at a second axial end of the connector for coupling to the second threaded shaft of the second member;
wherein the connector is configured to extend laterally from the power end unit to support the fluid end unit.

16. The connector of claim 15, wherein the connector includes a third bore extending from the first threaded bore to the second threaded bore, the first connector member and the second connector member each having a wall thickness that is greater in a region of the third bore than in regions of the first threaded bore and the second threaded bore.

17. A pump comprising:
a power end unit comprising a first structural member and a first reciprocating member, the power end unit being configured to output mechanical energy by reciprocally moving the first reciprocating member relative to the structural member, and the first structural member including a plurality of first mounting locations;
a fluid end unit comprising a second structural member and a second reciprocating member configured to be moved reciprocally by the first reciprocating member relative to the second structural member, the fluid end unit being configured to pump a liquid via the second reciprocating member, and the second structural member including a plurality of second mounting locations that are each aligned with an associated one of the first mounting locations; and
a mounting system that mounts the fluid end unit to the power end by coupling the first structural member to the second structural member, wherein the mounting system includes a plurality of mounting assemblies that each comprise:
a first end member removably coupled to the first structure at one of the first mounting locations;
a second end member removably coupled to the second structure at the second mounting location associated with the first mounting location; and
a coupling including a first end and a second end, the first end being removably coupled to the first end member, and the second end being removably coupled to the second end member.

18. The pump of claim 17, wherein the first end member of each mounting assembly includes a first threaded shaft received within the first structural member, and a second threaded shaft coaxial with the first threaded shaft and received within a first threaded bore of the coupling to form a first threaded connection therebetween; and
wherein the second end member of each mounting assembly includes a third threaded shaft received within the second structural member, and a fourth thread shaft coaxial with the first thread shaft and received within a second threaded bore of the coupling to form a second threaded connection therebetween.

19. The pump of claim 18, wherein the coupling of each mounting assembly comprises a first coupling member and a second coupling member that cooperatively define the first threaded bore and the second threaded bore.

20. The pump of claim 17, wherein each mounting assembly is removable from the pump without moving the fluid end unit relative to the power end unit.
